(19) United States
(12) Patent Application Publication
(10) Pub. No.: US 2002/0069412 A1
(43) Pub. Date: Jun. 6, 2002

(54) Three-panel display for selecting files

(76) Inventor: Ashwin Philips, Arlington, VA (US)

Correspondence Address: Greg Wertheimer, 51 Middlesex Street, Suite 125, North Chelmsford, MA, 01863, US

(21) Appl. No.: 09/732,202

(22) Filed: Dec. 6, 2000

(51) Int. Cl. H04N 5/445; G06F 13/00; G06F 3/00

(52) U.S. Cl. 725/43; 725/40; 725/44

(57) ABSTRACT

Provided is a technique for entering a file selection by simultaneously displaying a first region, a second region and a third region. Displayed on the first region is a list of categories of files. A first selection of one of the displayed categories is then input, so as to identify a selected category. In response to the first selection, a list of the files in the selected category is displayed on the second region. Thereafter, a second selection of one of the files displayed on the second region is input, so as to identify a selected file. Then, in response to the second selection, a name for the selected track is displayed on the third region.

### BACKGROUND OF THE INVENTION

1. Field of the Invention.

The present invention relates to a display that utilizes three regions for facilitating the selection of files, and particularly concerns a display that can be used in a stereo component for creating a play list from a database of audio tracks or for purchasing additional audio tracks.

2. Description of the Related Art.

Many conventional home stereo components, such as compact disc (CD) players, allow the consumer to program a play list from the audio available at any given time. In the case of a CD player that is capable of holding multiple CDs at once, the common conventional technique is to require the consumer to input for each audio track desired to be included in the playlist: the CD number (e.g., the numeric position for the CD in a carousel) and the track number on the CD. Unfortunately, such a technique can often be overly cumbersome for the consumer, requiring the consumer to keep track of which CD is installed in which position and what is the track number on the CD for each desired audio track.

More advanced programming techniques allow the consumer to program using the name of the CD and/or the name of each desired audio track. However, even these conventional techniques often can be difficult for the consumer to use, particularly in applications where there is a large number of audio tracks available.

### SUMMARY OF THE INVENTION

The present invention addresses this need by simultaneously displaying three regions that allow a user to view a list of categories, the files with a designated category, and a list of selected files.

Thus, in one aspect the invention is directed to entering a file selection by simultaneously displaying a first region, a second region and a third region. Displayed on the first region is a list of categories of files. A first selection of one of the displayed categories is then input, so as to identify a selected category. In response to the first selection, a list of the files in the selected category is displayed on the second region. Thereafter, a second selection of one of the files displayed on the second region is input, so as to identify a selected file. Then, in response to the second selection, a name for the selected track is displayed on the third region.

By providing such three regions, the present invention often can greatly facilitate browsing, searching and/or selecting files from a large group of files. In a more particular aspect, the invention inputs a third selection from a group of types of categories, so as to obtain a selected type, and the displayed categories are all of the selected type. In this manner, the invention can permit highly flexible user navigation through a group of files. As discussed in detail below, such techniques are particularly applicable to selecting audio/video tracks to be played or purchased.

In still more particular aspects of the invention, the selected type of category can be changed multiple times and each time a different type of category is selected, the displayed list of categories changes accordingly. This feature of the invention can allow a user to scan different categories of files very quickly and efficiently.

The foregoing summary is intended merely to provide a brief description of the general nature of the invention. A more complete understanding of the invention can be obtained by referring to the claims and the following detailed description of the preferred embodiments in connection with the accompanying figures.

### BRIEF DESCRIPTION OF THE DRAWINGS

FIG. 1 is a simplified block diagram of a representative main base unit for implementing the present invention.

FIG. 2 is a simplified functional block diagram of a representative system for implementing the present invention.

FIG. 3 is a flow diagram for explaining top-level user navigation through functionality provided by a system according to a representative embodiment of the present invention.

FIG. 4 is a flow diagram for explaining creation and playing of a play list according to a representative embodiment of the present invention.

FIG. 5 is a flow diagram illustrating a process for selecting and purchasing audio/video tracks according to a representative embodiment of the invention.

FIGS. 6A through 6E illustrate representative display screens for creating and playing a play list of audio/video tracks according to a representative embodiment of the invention.

FIGS. 7A through 7C illustrate representative display screens for selecting and purchasing audio/video tracks according to a representative embodiment of the present invention.

FIG. 8 is a flow diagram illustrating a method for downloading audio/video tracks according to a representative embodiment of the invention.

FIG. 9 is a flow diagram illustrating a method for playing a list of audio/video tracks according to a representative embodiment of the invention.

FIG. 10 illustrates a flow diagram of a method for downloading audio/video tracks to a portable device while controlling unauthorized copying, according to a representative embodiment of the invention.

### DETAILED DESCRIPTION OF THE PREFERRED EMBODIMENTS

Commonly-assigned patent applications titled “Secure File Downloading” and “Network-Enabled Audio/Video Player”, filed concurrently herewith, are incorporated by reference herein as though set forth herein in full.

The preferred embodiment of the present invention is primarily directed to a device for playing tracks or files that consist mainly of audio content (“audio”), such as recorded songs. However, in alternate embodiments the device may be primarily for playing tracks or files that consist mainly of video content or of a combination of audio and video content (“video”), such as recorded movies. In a still further embodiment, the device of the present invention is capable of playing either audio tracks or video tracks. As used herein, the term “audio/video” is intended to refer to either or both of audio and video. As used herein, the term “track” is intended to refer to any pre-recorded fixed segment of audio or video content. Also, even where the following discussion of the preferred embodiments refers to audio tracks, it should be understood that such references merely reflect the preferred embodiment of the invention. Such references are not intended to limit the scope of the invention. Rather, in general, all of the teachings described herein apply equally to playing/processing of audio tracks and video tracks.

In particular, the preferred embodiment of the present invention relates to various aspects of and improvements to the Lydstrom Songbank SL CD Memory System™ (the “Songbank”), sold by Lydstrom Inc. of Boston, Mass. (the present assignee). The Songbank primarily functions as a stereo component that has a high-storage-capacity internal hard disk and corresponding disk drive. By making it possible to maintain an entire audio library within a single (typically home) stereo component, the Songbank allows instant access to a wide variety of music and permits users to custom-generate, use and store play lists of different audio tracks. The audio tracks stored on the Songbank's hard disk may be pre-stored or copied from removable media, such as a compact disc (CD). Among the relatively new features of the Songbank is the ability to download audio tracks over the Internet, thereby making music and other audio tracks conveniently available to the consumer and ready for playing on-demand. Additional features pertain to security aspects directed to preventing unauthorized copying of such tracks.

In the preferred embodiment, the main functionality of the present invention is implemented primarily in a single box that functions as a stereo component for connecting to a home stereo system or, more generally, to a home entertainment system. Preferably, this main unit is sized, shaped and otherwise configured so as to fit within an ordinary home entertainment center. Thus, in the preferred embodiment the box enclosing the main unit has dimensions that are less than 10 inches high, 18 inches wide and 24 inches deep. In addition, the main unit preferably is designed to have a similar appearance to other conventional home stereo components.

Preferably also included with the main unit is a remote control unit for providing a user interface to the main unit. The remote control unit preferably is wireless (e.g., using infrared transmissions), although it may instead be hardwired to the main unit. In addition, the remote control unit may be a handheld unit, or may be larger so as to include either a reduced-sized or a full-sized alpha-numeric keyboard. For simplicity of discussion, unless the context requires otherwise, references to a device or system according to the present invention shall refer to the main unit only, it being understood that the interface controls may be provided on either or both of the main unit and any remote control unit.

In the preferred embodiment, the main unit according to the present invention is provided with: at least one built-in media player, such as a CD player; a mass internal storage unit, such as a hard disk drive, for storing audio/video tracks; an output for providing audio/video signals to an external device for playback by the external device; an output for downloading tracks in digital format to an external device; a video output for displaying a user interface on an external display monitor, such as a home television set or a computer monitor; and an Internet connection for downloading additional audio/video tracks. The device according to the present invention optionally may be provided with: one or more additional media players, such as one or more audio cassette players, one or more video tape players, and/or one or more DVD players; a remote control for controlling the functionality of the device; built-in speakers; and/or a built-in display screen.

System Configuration.

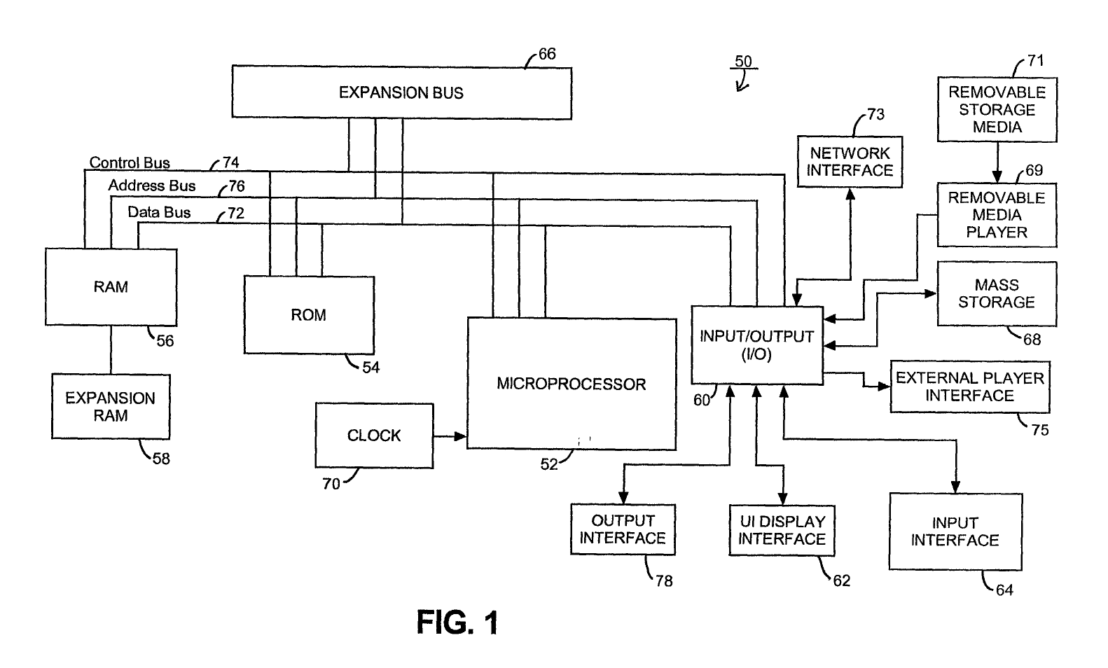

In the preferred embodiment, the device of the present invention is implemented using an open computer-based architecture, either with a single processor or with multiple processors. FIG. 1 is a block diagram of a system representing one of many suitable platforms for implementing the functionality and techniques described herein.

Specifically, FIG. 1 shows a computer-based open-architecture system 50 in accordance with the present invention. As shown in FIG. 1, system 50 includes a central processing unit (CPU) 52, read-only memory (ROM) 54, random access memory (RAM) 56, expansion RAM 58, input/output (I/O) circuitry 60, display interface 62, input interface 64, removable media player 69, mass storage device 68, external player interface 75, modem 73, and expansion bus 66. System 50 may also optionally include a real-time clock 70.

CPU 52 is coupled to ROM 54 by a data bus 72, control bus 74, and address bus 76. ROM 54 preferably contains instructions for starting executing the basic operating system of system 50 (which operating system preferably is initially stored in mass storage device 68) upon power-up of system 50. CPU 52 is also connected to RAM 56 by busses 72, 74, and 76. Expansion RAM 58 is optionally coupled to RAM 56 for use by CPU 52. CPU 52 is also coupled to the I/O circuitry 60 by data bus 72, control bus 74, and address bus 76 to permit data transfers with peripheral and/or certain internal devices.

I/O circuitry 60 typically includes a number of latches, registers and direct memory access (DMA) controllers. The purpose of I/O circuitry 60 is to provide an interface between CPU 52 and such peripheral devices as a home television set via interface 62, a remote control via input interface 64, a home stereo system via output interface 77, and a portable audio player via external player interface 75. 1/O circuitry 60 also permits communication with an internal removable media player 69 and mass storage device 68.

In the preferred embodiment of the invention, output interface 78 includes digital-to-analog converters for at least two audio channels and a RCA jack for providing analog audio signals to a home stereo system. In embodiments of the invention where display of video tracks is to be output, interface 78 also includes a chipset for converting generated image data into the appropriate output video format. Alternatively, any other appropriate hardware may be used for providing audio/video signals for playback by a desired external device.

User interface (UI) display interface 62 of system 50 preferably includes a chipset coupled to I/O circuitry 60 for converting user interface display image data generated by system 50 to the appropriate output format and an appropriate jack (e.g., a RCA jack for outputting those signals. In the event that system 50 is configured for playing video tracks, interface 62 may instead be omitted and the user interface display information output via interface 78.

Input interface 64 preferably comprises an infrared receiver for receiving control instructions from a wireless remote control unit. However, in the case of a hardwired remote control, interface 64 may instead comprise an appropriate jack or other connecting device.

External player interface 75 preferably comprises either a serial or parallel output data port for outputting digital signals to an external device. Any conventional output data port may be used, with the specific interface chosen to match the expected external device. Multiple such ports may be provided if it is contemplated that different types of external devices are to be used.

Mass storage device 68 preferably is implemented as a hard disk drive, such as any commercially available hard disk drive. However, any other magnetic, optical, opto-magnetic, solid state or other type of nonvolatile mass storage device may instead be used. Preferably, mass storage device 68 has a capacity of at least 10 gigabytes.

At least one removable media player 69 preferably is coupled to I/O circuitry 60 to read from, and in certain embodiments to write to, a removable storage medium 71. Removable storage medium 71 may represent, for example, a magnetic disk, a magnetic tape, an opto-magnetic disk, an optical disk, or the like. In the preferred embodiment of the invention, medium 71 is a CD and player 69 is a CD player.

One or more network interfaces 73 also are coupled to 1/O circuitry 60. Preferably interface 73 includes at least one of: (i) a telephone line modem and telephone jack for initiating dial-up connections, such as connections to an Internet Service Provider (ISP), to connect to a desired network; and (ii) a network interface card and network jack for directly connecting to a local area network (e.g., an ethernet).

In operation, information is input into system 50, depending upon the configuration of the remote control unit or the control panel on the device itself, by pressing buttons, typing on a keyboard, manipulating a trackball or other pointing device, “writing” on a pressure sensitive tablet or using any other input means. CPU 52 then processes the data under control of an operating system, preferably Windows CE™, and under the control of one or more application programs, such as a program to perform the steps of the inventive method described above, stored in ROM 54 and/or RAM 56. It is noted that ordinarily such process steps initially will be stored in mass storage unit 68, downloaded into RAM 56 and then executed out of RAM 56. In response, system 50, under the control of CPU 52, performs ay or all of the actions described below.

Expansion bus 66 is coupled to data bus 72, control bus 74, and address bus 76. Expansion bus 66 provides extra ports to couple devices such as additional network interface circuits, modems, display switches, microphones, speakers, etc. to CPU 52.

Suitable hardware for use in implementing the present invention may be obtained from various vendors. Various types of hardware, however, may be used depending upon the size and complexity of the tasks (e.g., whether the system will be processing video or only audio). Although a general-purpose computer-based system has been described above, special-purpose hardware, such as full custom chips, application specific integrated circuits, or programmable gate arrays, may instead be used.

It should be understood that the present invention also relates to machine-readable media on which are stored program instructions for performing the methods of this invention. Such media include, by way of example, magnetic disks, magnetic tape, optically readable media such as CD ROMs, semiconductor memory such as PCMCIA cards, etc. In each case, the medium may take the form of a portable item such as a small disk, diskette, cassette, etc., or it may take the form of a relatively larger or immobile item such as a hard disk drive or RAM provided in an audio/video component or a computer.

System Description.

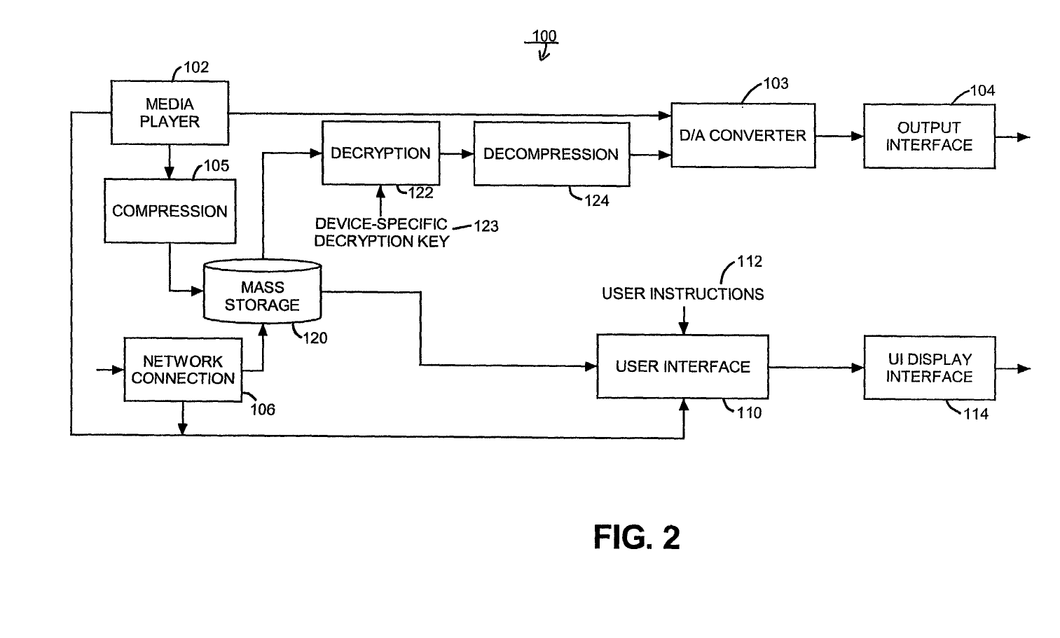

FIG. 2 illustrates a functional block diagram for explaining the operation of certain aspects of a system 100 according to a representative embodiment of the present invention. Included in system 100 is media player 102 which, for example, may include a CD player, a DVD player, a video cassette player, an audio tape player or any other device for playing audio/video content stored on a portable medium. Moreover, although media player 102 is shown as a single element in FIG. 2, it should be understood that multiple such media players may be included in system 100, either of the same and general type (e.g., two CD players) or of different types (e.g., a CD player and an audio cassette player).

In operation, a portable medium (such as a CD) is loaded into media player 102, and then media player 102 plays the audio/video content stored on such medium. Generally, such audio/video content will be stored on the medium in digital format. Accordingly, the playing by media player 102 will essentially involve reading such digital data and performing any necessary processing, such as decompression (in certain cases), error detection/correction, and/or implementing any security features. In addition to such audio/video content, the portable medium often will include additional information, which typically is in the nature of information characterizing the audio/video content stored thereon, such as an album identification number and a sequential list of the lengths of the individual audio/video tracks stored on the medium. The audio/video content read by media player 102 may be supplied to digital-to-analog converter 102 to be immediately played for the benefit of the end user. Alternatively, such audio/video content, together with any additional information stored on the portable medium may be stored into mass storage unit 120 for future use.

Digital-to-analog (D/A) converter 102 converts an input digital signal into an analog signal and provides that signal to output interface 104. Alternatively, D/A converter 102 may be omitted in the event that the output device is a digital device.

Output interface 104 preferably includes an interface for connecting to a home entertainment system. For instance, in the case that system 100 is primarily directed to processing audio content, output interface 104 preferably comprises two RCA jacks for connection to a home stereo system. It is also noted that it is possible to provide system 100 with its own internal audio amplifier and speakers so that no external device is required at all.

Mass storage device 120 generally corresponds to mass storage device 68 shown in FIG. 1 and preferably includes a hard disk drive. However, any other permanent storage device that is capable of storing a large amount of data may be used instead. As discussed in more detail below, mass storage device 120 stores a collection of audio/video tracks (or files) and preferably also stores a database of other information pertaining to various stored and/or non-stored audio/video tracks which may be helpful to the user in browsing and/or searching such tracks and to system 100 in retrieving desired tracks. Such information may include, for example, genre, album name, artist name, and an ordered list of tracks on the album for each of a large number of album identification numbers. Also, such information may include category type names, category names, album names, artist names, and track names for all stored tracks, as well as links showing the relationships between such data. In addition to storing content provided by media player 102, mass storage device 120 preferably also receives content via network connection 106.

Network connection 106 may be comprised of a network interface circuit for connecting to a local area network (LAN). More preferably, however, network connection 106 connects to the Internet. Accordingly, network connection 106 preferably comprises an ordinary telephone line modem, a cable modem or a digital subscriber line (DSL) interface, or any other Internet connection.

Once such audio/video content has been stored in mass storage device 120, that content can be read from mass storage device 120 and played. Initially, the audio/video content read from mass storage device 120 is decrypted, if necessary, in decryption module 122.

In this regard, either or both of the content provided by media player 102 and network connection 106 may have been encrypted. In the current embodiment of the invention, however, generally only the content provided by network connection 106 will have been encrypted. As described in more detail below, such content preferably will have been encrypted so as to be capable of decryption by using a device-specific decryption key. Thus, also input into decryption module 122 is device-specific decryption key 123 for use in performing any required decryption. It is noted that decryption key 124 may be stored, for example, in ROM 54 or in mass storage device 68, in the event that the system is implemented using the hardware architecture shown in FIG. 1.

Upon completion of any such required decryption, any required decompression is performed in module 124. In the preferred embodiment of the invention, system 100 is primarily for playing audio tracks and the compression technique utilized is Lucent Technologies™ ePAC™ compression. However, any other compression technique, such as MP3, may also or instead be used. In any event, decompression module 124 preferably detects the compression format and then applies the appropriate track-specific decompression technique. Upon completion of decompression, the audio/video content is provided to D/A converter 103 and the track is ultimately played on an appropriate output device (e.g., a stereo amplifier and/or speakers) via output interface 104.

For purposes of controlling the operations of system 100, system 100 also is provided with a user interface module 110. Input into user interface module 110 are: user instructions 112, information from mass storage device 120, information obtained via network connection 106, and information obtained from media player 102. As indicated above, the user instructions 112 preferably are provided via a wireless remote control device. However, such instructions 112 may instead be provided via a control panel built into system 100, or via an external device that is hard-wired to system 100.

The information provided by media player 102 to user interface module 110 generally will vary depending upon the type of media player and the type of medium it accepts. Generally, however, such information will be primarily directed to characterizing the audio/video content stored on the currently installed medium. In the case of a CD player, this information typically will include an album identification number and the playtime duration of each track stored on the medium.

In order to convert such information into something that will be useful to an end user, mass storage device 120 preferably stores a database of additional information pertaining to a number of different media (e.g., different CDs) which might be read by media player 102. For instance, in the event that media player 102 is a CD player, mass storage device 120 preferably stores and makes available to user interface 110 a database listing, for a large catalog of CDs: the album name and the list of audio tracks in the order that they appear on the album. By linking this information to the information provided by media player 102, user interface 110 can provide to the user information pertaining to the names of all CDs loaded on media player 102, as well as the names of all tracks on each such CD. In addition, system 100 preferably also is capable of reading text characterization information stored on those CDs that are encoded with such information.

Various remote network nodes provide to user interface 110, via network connection 106, the information pertaining to the audio/video tracks that are available for downloading. Such information may be in the form of actual names of the tracks, in which case no additional information generally will be required from mass storage device 120. Alternatively, such remote network nodes may merely provide minimal identification information, such as an album identification number for each available album to user interface 110. In this latter case, it generally will be necessary to access the audio/video track database stored in mass storage unit 120. In addition, such remote network nodes preferably also provide pricing information for such available tracks.

All such input information is synthesized by user interface module 110, using conventional graphic generation techniques to generate user interface display screens. In the preferred embodiment of the invention, system 100 runs Windows CE™ operating system, which provides known tools for creating such screens. Exemplary screens which may be used by system 100 are described in more detail below. In any event, such screens are output to user interface (UI) display interface 114.

UI display interface 114 converts the graphics and other display information provided by user interface module 110 into a format that can be displayed by an external display device. In the preferred embodiment of the invention, such external display device is an ordinary household television set. Accordingly, such information preferably is converted into the National Television Systems Committee (NTSC) standard format and is output via a RCA jack. However, other formats may instead be used, such as where it is contemplated to connect system 100 to a foreign television set or to a high definition television set. Various other display devices may instead be used that require different video formats. However, it generally will be preferable to output such display information in a format that can be displayed by a commonly used television set. Techniques and hardware for converting raster image data (which may be generated from graphic and other types of display data) into any desired video format are well-known in the art and therefore are not discussed in detail here.

As indicated above, system 100 preferably is implemented using the open hardware architecture 50 illustrated in FIG. 1, which mostly utilizes general-purpose computer hardware. As a result, in such an embodiment most of the functionality will be implemented in software, which may be stored on RAM, ROM, a hard disk or any other medium.

It is also possible to utilize special-purpose hardware for implementing any of the functionality described herein. The decision as to whether to use hardware, software, or a particular combination of each is preferably made according to well-understood engineering tradeoffs, including expected advantages in cost, speed, size, modification flexibility, and interchangeability. In any event, however, system 100 preferably is a closed system, in the sense that the system is not easily modified by the end user. Thus, even where an open architecture is used, such as system 50 shown in FIG. 1, the software driving the system is not generally accessible to the end user. Instead, the end user is only given access to the system's functionality through the specifically defined interfaces provided by user interface 110. Ordinarily, such access will not permit the end user to modify the software itself, except possibly in limited cases in order to alter specifically defined configuration settings.

System Operation

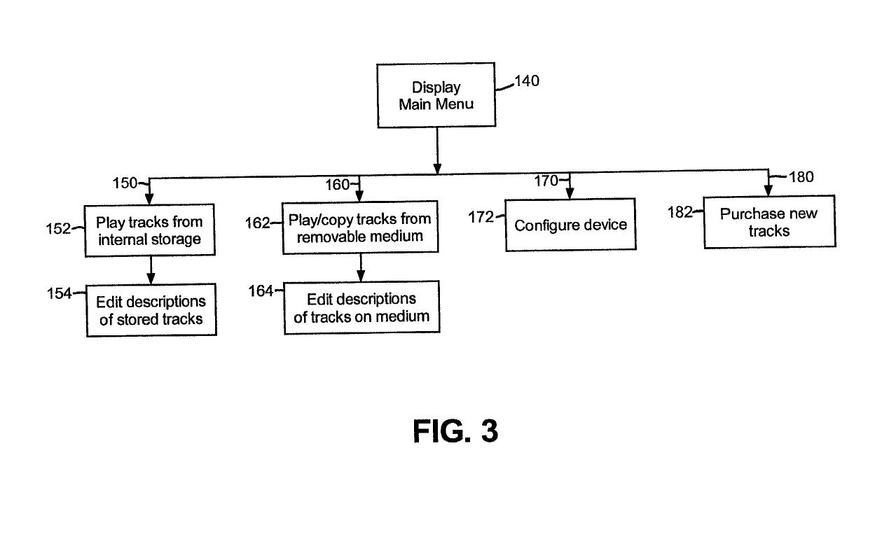

FIG. 3 illustrates a flow diagram for explaining a general flow of processing performed by system 100. Initially, in step 140, a main menu is displayed. The main menu preferably shows a number of different high-level options that the user may elect. Some of these options are illustrated as branches 150, 160, 170 and 180. Preferably, the user may select any one of the displayed options and, in response, system 100 enters the selected mode. The actual selection process may be implemented using any conventionally available technique. However, in the preferred embodiment, the user interacts with system 100 using a wireless remote control. More specifically, the user preferably navigates through the list using arrow keys provided on the remote control. For example, each time a down-arrow key is pressed, the next entry on the displayed list is highlighted. In order to select a desired option, the user simply highlights it and presses a “select” or similar button on the remote control.

In more detail, when option 150 is selected, system 100 enters a mode in which the user may play tracks stored on mass storage device 120. In addition, in step 154 the user may edit descriptions of stored tracks. These features and other possibilities in connection with option 150 are described in more detail below.

In the event that the user selects option 160, then in step 162 the user may cause system 100 to directly play tracks stored on a medium that has been loaded into media player 102 or copy such tracks to mass storage device 120. In addition, in step 164 the user may edit the descriptions of either the album or the tracks available on the currently loaded medium. Step 162 preferably requires the user to select tracks that are available on the currently loaded medium to create a play list and then enter a command to play the play list. The actual play operation is similar to that used by conventional media players. Accordingly, step 162 may include other conventionally available play features, such as stop, pause, shuffle, random play, advance to next track, and so on. Step 164 is similar to step 154 and allows the user to edit descriptions of tracks, albums, etc., which information is then stored into the database in storage 120. Preferably, any user-specified changes in step 154, 164 or otherwise are stored separately from the remainder of the database or are otherwise designated so that any periodic updates to the database do not overwrite such changes.

In the event that option 170 is selected by the user, in step 172 the user is given the ability to alter configuration settings for system 100. Such settings may include, for example, the quality setting at which audio/video tracks are recorded to mass storage device 120 and/or whether an auto-eject feature is turned on or off. The former translates directly into the degree of compression that will be performed by compression module 105 prior to storage in mass storage 120.

In the event that option 180 is selected, then in step 182 the user is provided with the ability to purchase or otherwise download new audio/video tracks via network connection 106. This step is described in more detail below.

Although the steps shown in the flow diagram of FIG. 3 are illustrated in a particular order, it should be understood that the illustrated order is for ease of understanding only. In the preferred embodiment of the invention, the user has the ability to freely navigate among this various functionality without constraint as to order. In addition, the steps illustrated in FIG. 3 may even be performed concurrently. Thus, for example, a user may initiate playing of a track installed on player 102 in step 162 and then, while such track continues to play, move to step 152 to begin assembling a play list and to be played from mass storage device 120. Still further, while such a play list is being generated, the user may periodically jump to step 182 to purchase and download new audio/video tracks that she wishes to be included in the play list, returning each time to step 152 to continue constructing the play list from tracks already stored on mass storage device 120, all while listening to a track played from media player 102. Such processing may be performed, for example, using parallel hardware, multi-threaded tasking, or any combination of these.

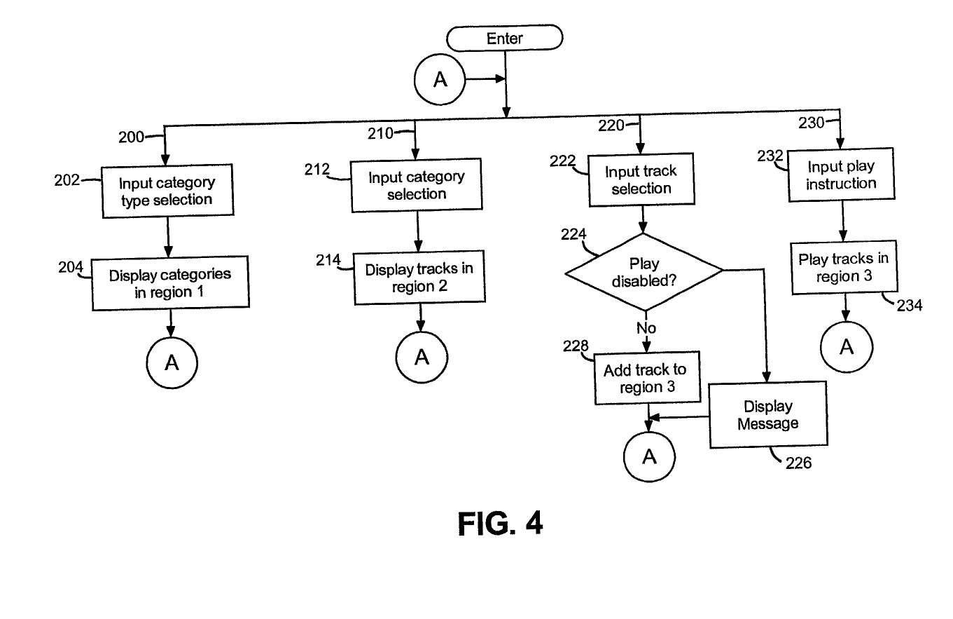

FIG. 4 illustrates a flow diagram for explaining one possible implementation by system 100 of step 152, shown in FIG. 3. Initially, it is noted that although the steps shown in FIG. 4 are illustrated in a particular order, that order is for ease of illustration only. Similar to the case with FIG. 3, the steps shown in FIG. 4 preferably may be selected by the user in any arbitrary order, thereby further enhancing the utility of system 100 to the end user. Once again, any technique may be used for selecting such options. However, the preferences discussed in connection with FIG. 3 above also apply here.

In the event that option 200 is selected, then in step 202 system 100 permits inputting of a category type selection. When applied to an embodiment that involves audio track selection, such category types might include, for example: “genre”, “artist” and/or “album”. Similar category types maybe used in connection with video track selection. In this case, the category types might include, for example: “genre”, “writer”, “actor”, “director” and/or “producer”. Upon selection of a category type, then in step 204 categories that fall within that category type preferably are displayed in a first region of the user interface display. For example, if the category type “genre” has been selected, then the first region preferably would display all the different genres of audio/video tracks that are currently represented in mass storage device 120.

In the event that option 210 is selected, then in step 212 system 100 inputs a category selection, preferably from the list of categories displayed in step 204. In this regard, it is noted that in the preferred embodiment of the invention, at least three different regions are provided in the user interface display, preferably three non-overlapping regions with clearly defined borders. However, it is also preferable that only one of such regions is active at a time, and the user is permitted to select only those items that are displayed in the active region. Thus, the category selection for purposes of this step 212 preferably is made by the user activating the first region of the display and then selecting who the desired category from the displayed list. Upon completion of such category selection, then in Step 214 the tracks corresponding to the selected category are displayed in region 2. For example, if the user had selected the category type “genre” and the category “jazz,” then in step 214 all audio tracks that are classified within the jazz genre and are stored on mass storage device 120 would be displayed in the second region of the display screen.

For purposes of the display in steps 204 and 214, it may be necessary to access the characterization information database stored in mass storage device 120, as discussed above. Also, most of the processing for identifying the categories under a selected category type and/or the tracks under a selected category may be made in advance or on-the-fly. With regard to the former, the database in mass storage device 120 would either maintain current lists of all categories under each category type and all tracks under each category or maintain links associating such entries. Thus, the necessary category or track information could be retrieved with little effort. On the other hand, performing most or all of the processing on-the-fly generally would involve an exhaustive search over all categories or all tracks to identify which entries indicate that they belong to the selected category type or category, respectively. Still further, any combination of these two techniques may be utilized.

In the event that option 220 has been selected, then in step 222 system 100 inputs a track selection, which generally will have been made by the user. Although such track selection may be made in any manner, in the preferred embodiment of the invention, track selection is accomplished by highlighting and then selecting one of the tracks displayed by step 214 in the second region of the display screen.

Once a track selection has been made instep 222, a determination is made in step 224 as to whether the selected track has been disabled from being played. In this regard, in the preferred embodiment of the invention, tracks stored in mass storage device 120 have associated flags indicating whether play has been disabled. This feature of the invention is described in more detail below. In the event that play has been disabled, then a message to that effect is displayed in step 226. Otherwise, an entry for the track is added to the third region of the display screen in step 228.

In the event that option 230 has been selected, then in step 232 system 100 inputs a play instruction from the user. In response to the play instruction, in step 234 system 100 commences playing all tracks listed in the third region of the display screen. This step 234 is described in more detail below.

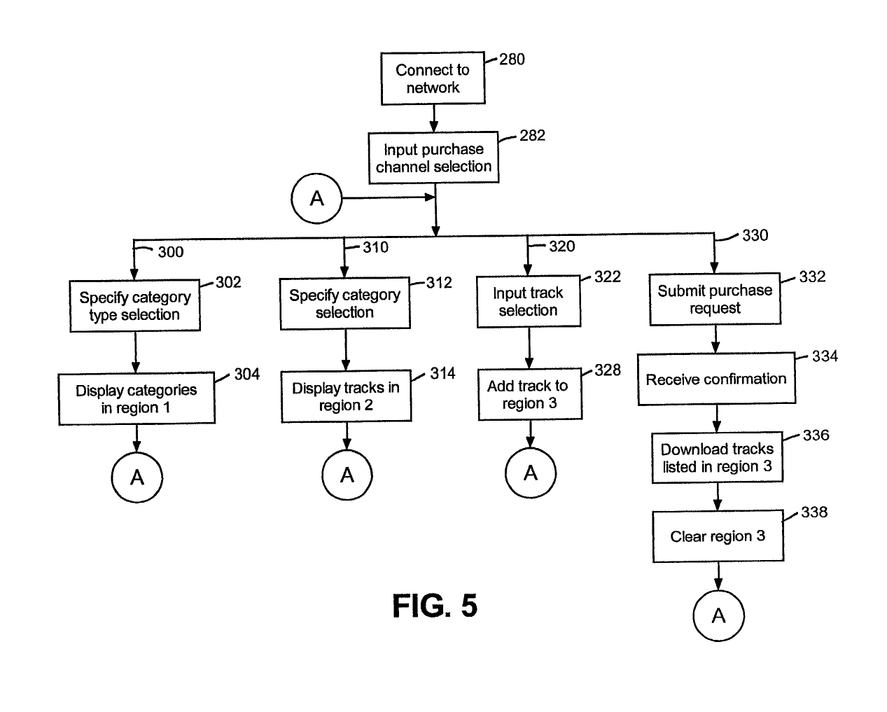

FIG. 5 illustrates a flow diagram for implementing step 182 (shown in FIG. 3) according to a representative embodiment of the invention. As with step 152 (also shown in FIG. 3), step 182 also involves the creation of a list of tracks. Thus, certain of the steps shown in FIG. 5 will be identical or very similar to corresponding steps shown in FIG. 4. In addition, the user interface displayed with respect to the method shown in FIG. 5 preferably is substantially similar to the user interface displayed in connection with the method of FIG. 4. At the very least, it is preferable that the display interface for the method of FIG. 5 also includes three regions, corresponding to the three regions of method of FIG. 4. In addition, it is preferable that the overall look and feel of the two user interfaces are substantially similar. More preferably, the two user interfaces are substantially identical, except to the extent changes are required or desired due to underlying changes in the goals of the two methods. In this regard, it is noted that, unlike step 152, which concerns creation of a list of tracks to be played, step 182 involves creating a list of tracks to be purchased (or otherwise downloaded).

The initial step of the method illustrated in FIG. 5 is to connect to the network in step 280. As noted above, the network used preferably is the Internet and all communications between the remote Internet node and system 100 are in accordance with the TCP/IP protocols. However, any other network may instead be used. The precise method for connecting to the network will depend upon the nature of the connection to be made, as well as the network to which connection is being made. In the event that a modem dial-up connection to an Internet service provider is the desired connection method, then such a dial-up connection will be initiated in this step. On the other hand, if the connection is made via cable, DSL or some other broadband service, it is likely that the network connection will be permanently established, obviating the need for this step to 80.

In step 282, system 100 inputs a purchase channel selection, preferably made by the user. In this regard, in the preferred embodiment of the invention, only pre-identified channel affiliates who have an existing relationship with the provider of system 100 are eligible to download audio/video tracks to system 100. A list of such purchase channel affiliates preferably is displayed to the user and the user is allowed to select one.

It is noted that the extent of involvement of the various purchase channel affiliates may vary according to the particular embodiment of the present invention. In the presently preferred embodiment of the invention, the provider of system 100 is solely responsible for communicating with the various systems 100 that are connected to the network. In such an embodiment, the purchase channel affiliates generally communicate only with the provider of the systems 100 and limited to matters such as: providing branding, setting prices, and offering other special deals, although more extensive involvement by the purchase channel affiliates also is possible. In any event, a distinguishing feature of the preferred embodiment of the invention is that the library of audio/video tracks available for download to the various systems 100 is controlled exclusively by the provider of system 100. Also in the preferred embodiment, all communications between the various purchase channel affiliates and each system 100 ultimately are controlled by the provider of the systems 100.

However, other embodiments of the invention are contemplated in which some or all of the communications from the purchase channel affiliates to each system 100 are made directly between those two entities. In such alternate embodiments, it is also possible for each such purchase channel affiliate to maintain its own library of audio/video tracks for downloading. Still further, it is also possible to implement the techniques of the present invention using purchase channel entities that are not at all affiliated with the provider of system 100.

As with FIGS. 3 and 4, the order of the steps shown in FIG. 5 is for purposes of illustration only. It is intended that the user may navigate arbitrarily among such steps, selecting various category types, various categories under those types, and various tracks under those categories in order to generate their lists of desired tracks.

In the event that the user selects option 300, steps 302 and 304 are performed by system 100. From the user's perspective, these steps functionally are substantially similar or even identical to steps 202 and 204, respectively. However, in this case the list of categories displayed in step 304 is generated by the remote network node, with which system 100 is communicating. In particular, such information is downloaded from the remote network node into system 100 and displayed by system 100, preferably in a similar manner to the display in step 204.

In the event that the user selects option 310, then steps 312 and 314 are performed by system 100. Once again, from the user's perspective, these steps are substantially similar or identical to steps 212 and 214, discussed above. However, in the current mode, the processing by system 100 requires communicating the category selection to the remote network node and downloading the list of tracks to be displayed from the remote network node.

In the event that the user selects option 320, steps 322 and 328 are performed by system 100. In step 322, system 100 inputs a track selection, preferably via user interface 110, and in step 324 identification information for the specified track is saved and displayed in the third region of the display. These steps are substantially identical to steps 222 and 228, respectively.

In the event that option 330 is selected by the user, system 100 performs steps 332, 334, 336, and 338. In step 332, system 100 submits the purchase request to the remote network node. Preferably, system 100 merely transmits a list of the desired tracks, together with user account identification information for payment/billing purposes. Alternatively, some or all of such information may be transmitted only after establishment of a secure connection (e.g., using encryption) between system 100 and the remote network node.

Upon receipt of the purchase request, the remote network node preferably evaluates the provided account information to determine whether a sufficient balance exists to pay for the requested tracks. If so, the purchase transaction is continued and a confirmation notification is sent to the system 100. In step 334, such confirmation notification is received by system 100.

Thereafter, the remote network node begins downloading the purchased tracks to system 100. In the preferred embodiment of the invention, each system 100 has been assigned its own unique identification code. This identification code may be directly used as a decryption key or else a decryption key may be obtained or derived from the identification code according to a predetermined algorithm. For example, the identification code might consist of two concatenated numbers with the decryption key being generated by multiplying those numbers together.

In any event, each track downloaded by the remote network node preferably is encrypted so that it can only be decrypted using the unique decryption key corresponding to the specific system 100 to which the track was addressed and sent. Such encryption may be performed by obtaining or deriving an encryption key based on identification information received from the system 100. For example, the remote network node may use such identification information as a pointer into a lookup table may process the identification information using a predetermined algorithm (which itself may be cryptography-based) to obtain the encryption key, or may directly use such identification information as the encryption key. Preferably, any such direct transmission of the encryption key is only performed over a secure connection. It is also noted that the encryption key may be the same as the decryption key (if symmetric encryption is used) or different (if asymmetric encryption is used). In addition, each downloaded track may be separately encrypted using a session encryption technique and corresponding encryption code.

Thus, In one embodiment of the invention, after an initial contact message from system 100 to the remote network node, a secure communications link is established between the remote node and system 100 using an asymmetric or public key encryption technique. System 100 then transmits (if it has not already transmitted) a unique identification code to the remote node to identify itself. Upon receipt of this identification information, the remote node retrieves an encryption key corresponding to this particular system 100 and then further encrypts each track using that encryption key. It is noted that ordinarily each such track will have been compressed prior to encryption. Preferably, the remote node also downloads identification information pertaining to each such track (e.g., track name, artist, album and genre).

In step 336, the system 100 receives the requested tracks via network connection 106. In this step 336, decryption is performed only with respect to the session encryption, if any. Each downloaded track preferably is then stored onto mass storage device 120 still in its device-specific encrypted state and still retaining any compression applied by the remote network node. Also in this step 336, the identification information pertaining to each track provided by the remote node is stored into the database located in mass storage device 120, for use in future browsing and/or searching by the user.

Finally, in step 338 the list of tracks in the third region of the display is cleared. As a result, the user can begin adding new tracks for purchase.

In the foregoing description, it is assumed that the entire database of tracks available for download is maintained solely at the remote network node. However, it is also possible for system 100 to maintain a duplicate copy of such information in mass storage unit 120. In this case, the remote network node might initially download the database, or even cause it to be pre-installed on system 100's hard disk 120, and then provide periodic updates encoded on a computer-readable medium or by downloading via network connection 106. Such a database caching technique may have the effect of reducing network traffic and increasing access speeds.

Regardless of where such information is maintained, it may be preferable to include within system 100 additional steps to display to the user only those tracks that are available for download that are not already stored in system 100 (e.g., in mass storage unit 120). Such a step can be easily implemented by comparing a list of tracks available for download to a list of tracks stored in system 100 and then eliminating the stored ones from the displayed list.

Moreover, such a step can be further enhanced by registering an entry in the list for the tracks on any media read by media player 102 (or, in a somewhat different embodiment, only those tracks specifically designated by the user) and then also eliminating such registered tracks from the displayed list of tracks available for download. In this way, the user can be spared having to view tracks of which he already owns a copy. By giving the user the option to designate only desired tracks on such removable media (or to simultaneously designate all tracks at once on a designated specific medium), the inventive technique accounts for the fact that certain media which the user loads into media player 102 may simply be borrowed and, therefore, the user may still wish to purchase one or more tracks on any such medium.

Finally, in the description above, it is assumed that a perpetual license to use each desired track is purchased. However, it is also possible to utilize the foregoing technique to purchase copies of tracks that may be used only temporarily. For example, the user may have the option of purchasing a track that is limited to a fixed number of plays or a fixed duration of playing time. Upon expiration of the limited license, the system 100 would automatically disable further play of the track and/or delete the track from its internal storage. To implement such a method, it generally will be necessary to store with each such track an indicator of the remaining number of plays or amount of play time. Such an indicator preferably would be automatically decremented by system 100 when the track is played (e.g., in step 234).

In a similar technique, a track is licensed for a fixed duration of time, with the user being able to play the track an unlimited number of times during such duration. In this case, system 100 would generally need to store an expiration date for the track and then delete and/or disable the track after such expiration date. Various other temporary licensing techniques can be easily implemented using the methods and apparatuses of the present invention. Because no physical medium ordinarily needs to be delivered with a track according to the present invention, it is possible to flexibly structure such arrangements. Moreover, because system 100 preferably is a closed system, it generally will be difficult for the average consumer to defeat the play limitations imposed by the seller, thus significantly reducing the disadvantages of making available large numbers of copies of purportedly limited life.

It is noted that whenever a reference is made herein to purchasing a track, such reference is intended to include acquisition of a license to use the track. As indicated above, such a license may either be perpetual, time-limited or usage-limited. In any event, any such a license typically will have other implicit or explicit restrictions regarding the acquirer's rights to the track.

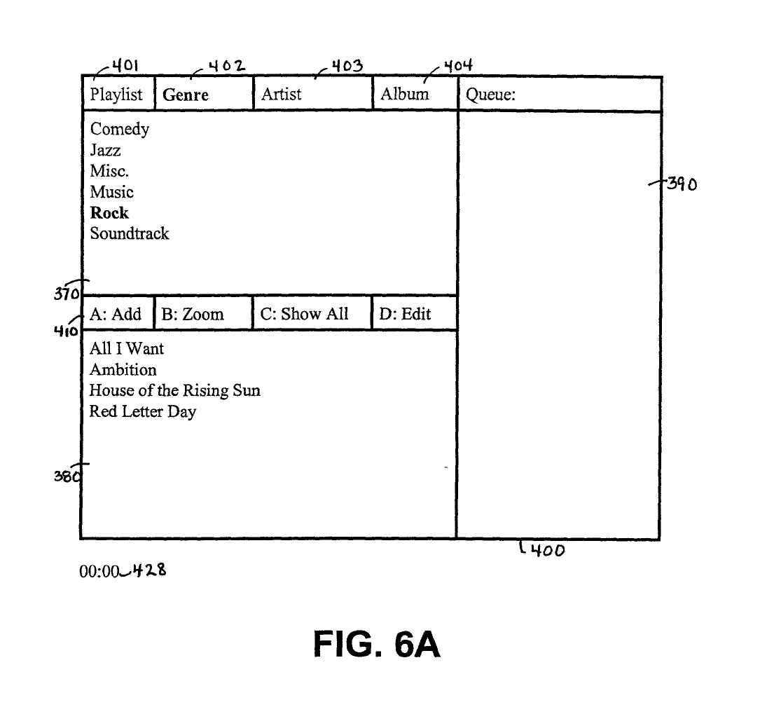

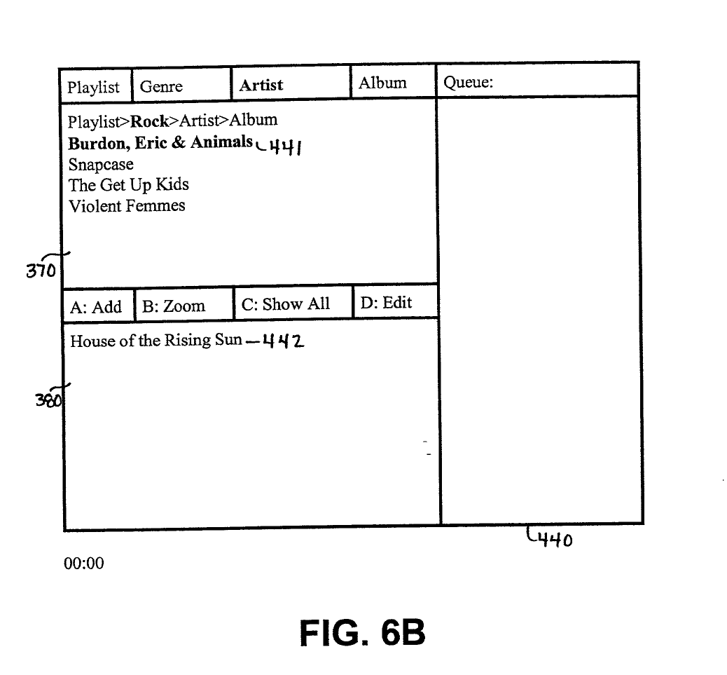

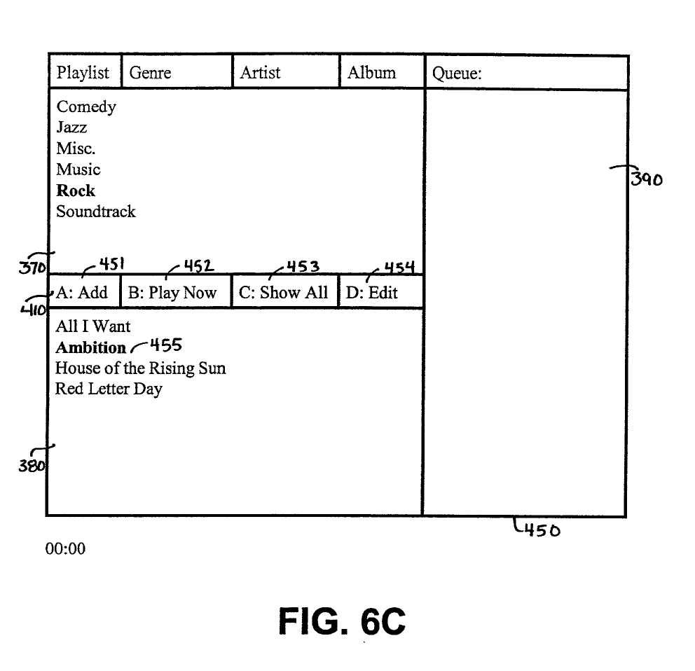

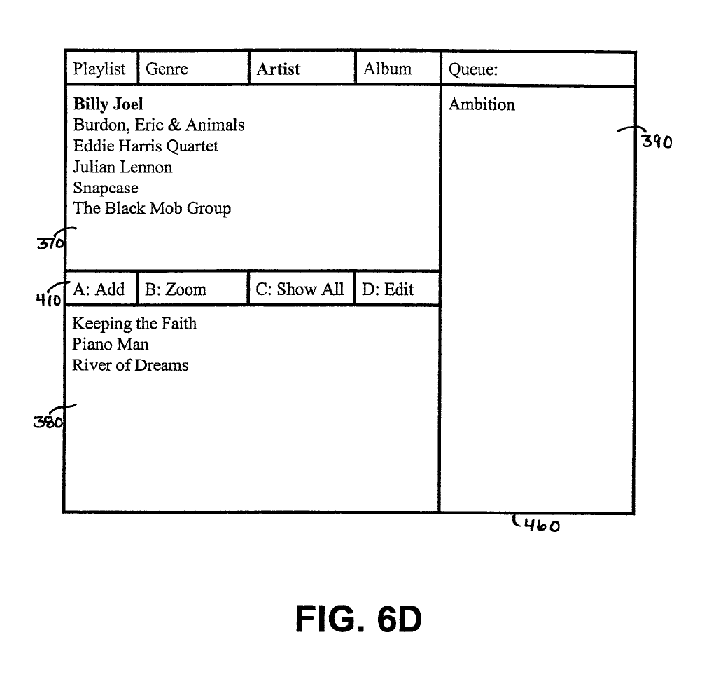

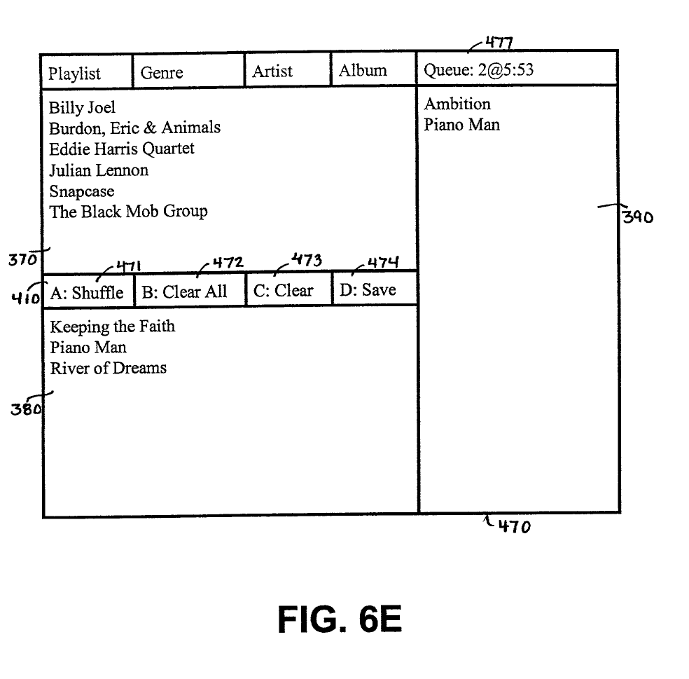

FIGS. 6A through 6E illustrate exemplary display screens that may be provided to a user in connection with the method illustrated in FIG. 4. The basic format of each such display screen can be seen with reference to FIG. 6A. Included in each display screen are three regions (or panels): a first region 370, a second region 380, and a third region 390. Above first region 370 is displayed a group of different category types: Play List 401, Genre 402, Artist 403 and Album 404. Between first region 370 and second region 380 is a number of soft buttons 410. Also included is a countdown timer 428 for displaying the amount of remaining play time on any track that is currently playing. Generally speaking, first region 370 is for displaying categories, second region 380 is for displaying tracks and third region 390 is for displaying a play list (or queue) of tracks selected by the user.

Preferably, only one of regions 370, 380 and 390 is “active” at a time, and the user preferably is only allowed to highlight and select items within the currently active region. Moreover, preferably at least some of soft buttons 410 correspond to different functionality depending upon which region is currently active. More preferably, in each case the new functionality associated with the soft button is displayed as the display screen changes.

In the display screen 400 shown in FIG. 6A, the user has selected the category type “genre”. Thus, the genre category type 402 is highlighted in FIG. 6A. In the preferred embodiment of the invention, the user selects a category type by pressing a corresponding dedicated button on a wireless remote control unit. Thus, the remote control unit has dedicated buttons for “Play List,” “Genre,” “Artist,” and “Album.” However, any other selection technique may instead be used and generally will depend on the user interface control panel. For instance, the desired category type may be selected by pointing to a corresponding tab using a track ball or a touch pad and then pressing a “select” button.

As a result of this category type selection, all genres of music that are currently represented by the stored tracks are displayed in first region 370. Ordinarily, second region 380 would display all tracks that are available in mass storage unit 120. However, in this case, the user has also selected a particular category within the selected category type, the “rock” genre. As a result of doing so, system 100 automatically changes display region 380 to display only those stored tracks that are of the rock genre.

Preferably, the category selection (i.e., the specific genre in this case) is performed by scrolling through the category list in region 370 using “up” and “down” buttons on the remote control. In response to down-scrolling, consecutive categories are highlighted one at a time. Similarly, in response to up-scrolling, previous categories are consecutively highlighted one at a time. When the desired category has been highlighted in the preferred embodiment, the user may select it by pressing a “select” button on the remote control. Once again, however, any other selection technique may instead be used, such as using a pointing device to highlight the desired category or typing the first couple of letters of the category name.

It is noted that in response to a selection of a category type, system 100 automatically makes active the first region 370. In order to change the active region, the user preferably presses a dedicated button on the remote control. For example, to make second region 380 active the user preferably presses a “songs” button on the remote control, and to make the third region 390 active the user preferably presses a “queue” button on the remote control. However, any other conventional designation technique may instead be used for this purpose.

The soft buttons currently available (with the first region 370 active) are: Add 421, Zoom 422, Show All 423, and Edit 424. Each of these soft buttons has a corresponding letter A through D. Preferably, the remote control also includes buttons labeled A through D. Thus, to activate the indicated functionality, the user simply has to press the appropriate button A through D.

Preferably, the functionality of the soft buttons is as follows: Add button 421, preferably adds all tracks listed in the second region 380 to the play list (i.e., third region 390); Zoom 422 permits display of categories in first region 370 that are members of the intersection of two category types, as discussed below in connection with FIG. 6B; Show All 423 preferably resets the display in first region 370 and second region 380 so that region 370 either displays nothing or displays categories from a default category type and region 380 displays all tracks available in mass storage 120; and Edit 424, preferably brings up a different screen which allows the user to edit the name stored in the database in mass storage 120 for the currently highlighted category.

Pressing button D for Zoom 422 with the display shown in FIG. 6A results in the display of screen 440 shown in FIG. 6B. Specifically, region 370 now displays all artists having tracks in the rock genre that are represented in mass storage device 120. By pressing the “album” button on the remote control, the display in region 370 changes to list all albums that include tracks of the rock genre.

Initially, region 380 continues to show all tracks of the rock genre. However, upon highlighting one of the categories displayed in region 370, region 380 changes to display on those tracks that belong to both categories. In the present example, region 380 only displays those tracks 442 that are of the rock genre and that were performed by the highlighted artist 441.

Returning briefly to FIG. 6A, pressing the “songs” button on the remote control results in the display of the screen 450 shown in FIG. 6C. In this screen 450, second region 380 is now active and the soft buttons 410 have changed as indicated. Preferably, the soft buttons now function as follows: Add button 451 adds all of the tracks listed in region 380 to region 390 (if no track has been highlighted in region 380) or adds only the highlighted track to region 390 in the event a track has been highlighted; Play Now button 452 causes system 100 to immediately play the highlighted track; Show All button 453 performs the same function as button 423 shown in FIG. 6A; and Edit button 454 brings up another screen that allows the user to edit the displayed title of the highlighted track. With a track 455 highlighted as shown in FIG. 6C, the user only has to press the “add” button 451 or the “select” button to add that track to the play list of region 390.

FIG. 6D illustrates a display screen 460 which would occur if the “artist” button were pressed on the remote control. Here, all artists having stored tracks are displayed. Moreover, by selecting a category type (i.e., artist in this case), the first region 370 once again becomes active. As a result, the soft buttons 410 are identical to those shown in screen 400 (shown in FIG. 6A).

FIG. 6E illustrates a screen 470 that is displayed by system 100 in the event the “queue” button is pressed on the remote control. Here, the third region 390 is the active region. As a result, the functionality of the soft buttons 410 has changed as follows: Shuffle 471 randomly shuffles the order of the list displayed in region 390; Clear All 472 deletes all entries from region 390; Clear 473 deletes only any highlighted entry displayed in region 390; and Save 474 allows the user to save the current play list under a user-defined name. It is noted that once a play list has been saved in the foregoing manner, pressing the “play list” button on the remote control (i.e., selecting the play list category type) will cause that play list name, as well as the names of any other previously saved play lists, to be displayed in first region 370.

Also provided in Display Screen 470 is play list summary information 477 which indicates the number of tracks currently on the play list and the total play time for all such tracks. As indicated above, the play time for each track is stored in the track database in mass storage unit 120. Accordingly, the total play time can be calculated as the sum of the individual play times for all tracks listed in region 390. System 100 plays the play list shown in region 390, preferably in the order listed, in response to the user simply pressing the “play” button on the remote control.

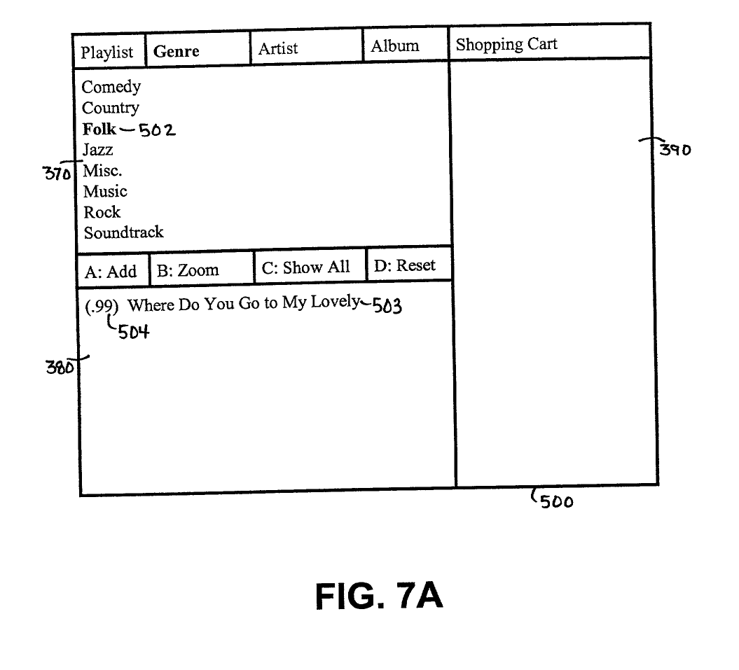

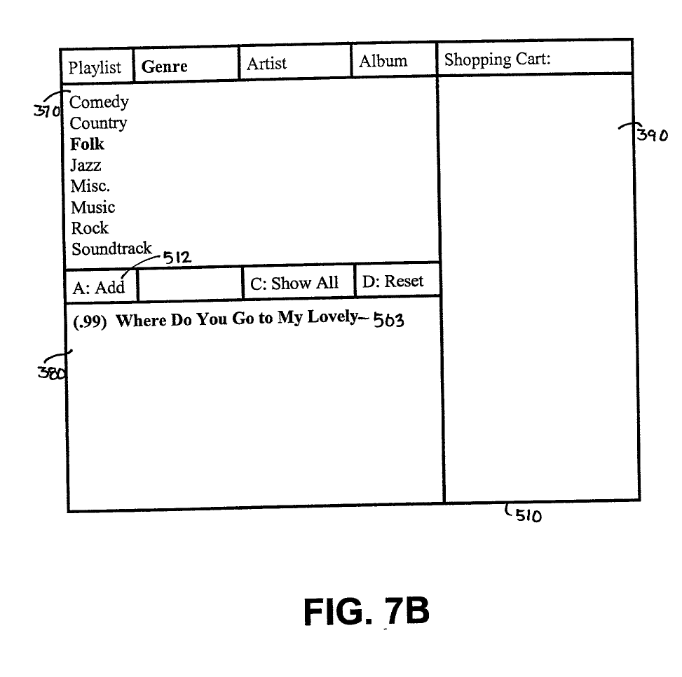

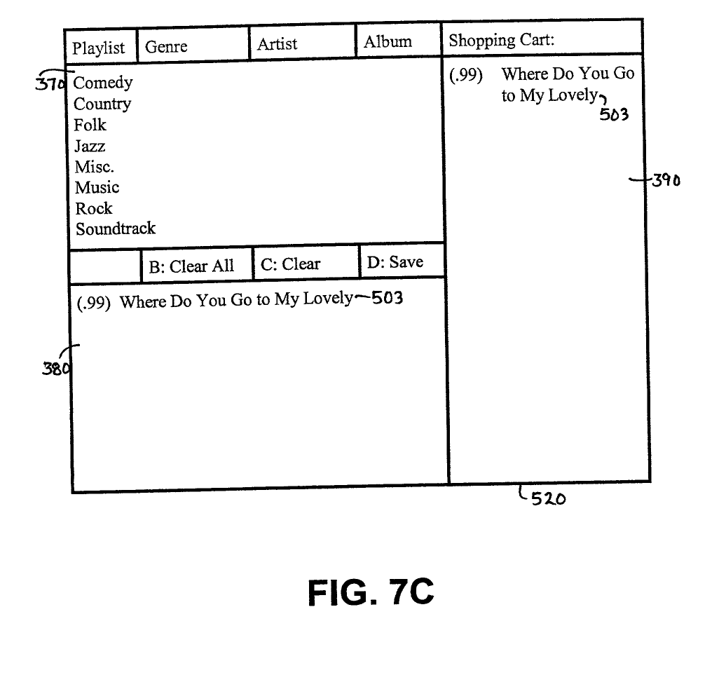

FIGS. 7A through 7C illustrate representative display screens that may be used by system 100 in connection with the method of FIG. 5. As noted above, from the user's perspective, these screens preferably will be quite similar to the screens used for generating a play list (e.g., FIGS. 6A through 6E).

In FIG. 7A, the user has indicated that he wishes to purchase audio/video tracks. The initially displayed screen is screen 500, shown in FIG. 7A. In this embodiment, the initial category type (i.e., the default category type) is “genre”. Accordingly, first region 370 includes a list of the different genres from which audio/video tracks are available for downloading. Initially, second region 380 would show an alphabetical listing of all tracks of available for downloading. However, in screen 500 the user has highlighted category 502, “folk”. Therefore, second region 380 only displays those tracks available for downloading that are of the folk genre.

It is noted that, other then the specific categories and tracks displayed, the only significant difference between screen 500 and screen 400 is that in screen 500 the caption for the third region 390 is “Shopping Cart”, rather than “Queue”. Generally, in the preferred embodiment of the invention, the display screens are made as identical as possible so as to provide the user with as seamless a navigation experience as possible. Another difference is that each track listed in second region 380 preferably also includes a price 504 at which the track can be purchased.

In the event that a number of different purchase options are available (which may include various limited-use licenses and/or any special deals, such as “buy one get one free”), such additional pricing information my also be displayed in region 380. However, the more extensive such information is, the more preferable it will be to display a separate screen that includes such different pricing options. In one such example, the ordinary purchase price for a perpetual license is displayed in region 380, as shown in FIG. 7A. In the event that the user desires such additional pricing options, the user would first highlight the track of interest and then press a pricing button (either hard or soft). In response to this action, a new screen would be displayed showing such information. Preferably, such new screen would only occupy the area of region 380. After such information has been reviewed, and possibly after a pricing option has been selected from such screen, the user could then return to the base screen, such as shown in FIG. 7A.

FIG. 7B illustrates a display screen 510 which would result if the user were in display screen 500 and pressed the “songs” button on the remote control, and then highlighted track 503. It is noted that the format of screen 510 is substantially identical to that of screen 450 (shown in FIG. 6C), except that the “Play Now” soft button 452 is omitted in display screen 510. This is because in the present embodiment of the invention, it is not possible to play tracks prior to downloading. However, in alternate embodiments of the invention, such a “Play Now” button or a “Play Sample” button may be included so that a user could preview a track prior to determining whether or not to purchase it. It is noted that in order to implement such an embodiment, system 100 preferably would be modified so that network connection 106 connects to output interface 104 through a D/A converter and through any necessary decryption and decompression modules.

FIG. 7C illustrates a display screen 520 which would be provided if a user in display screen 510 were to press the “Add” soft button 512. As a result of this action, audio track 503 has been added to third region 390.

The foregoing processes may be repeated to add additional tracks to region 390. Once the user has completed this process, she may cause system 100 to submit a purchase request such as by pressing an “order” button. Alternatively, an intermediate step may be provided in which the order information is transmitted to the remote network node and the remote network node transmits back information regarding the total cost and any other terms, such as shipping terms. Upon review of such information, the user may then be provided with the option of either continuing with the order or cancelling the order. As noted above, if the purchase request is in fact submitted, a confirmation message preferably is displayed and then the audio/video tracks begin downloading.

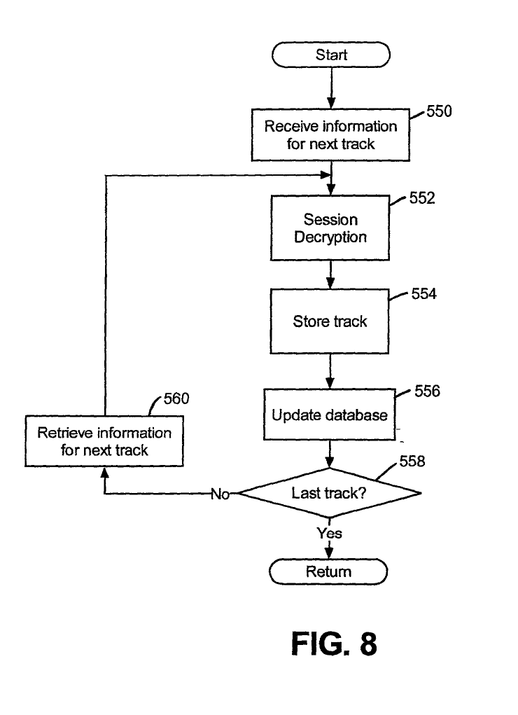

FIG. 8, illustrates a flow diagram for explaining audio/video track and downloading according to a representative embodiment of the invention. Initially, in step 550, the track is received via network connection 106.

In step 552, any required session decryption is performed. Generally, such decryption will be performed only in the event that the track was received over a secure connection. Any of the known encryption/decryption techniques may be used for this purpose. Accordingly, the specific decryption technique used in step 552 will depend upon the established protocol. It is noted that a session decryption module is not shown in FIG. 2 because not all embodiments of the invention will use session encryption.

In step 554, the track is stored into mass storage device 120. It is noted that in the preferred embodiment of the invention, the track is stored as compressed and as encrypted with any device-specific encryption technique.

In step 556, the track database in mass storage device 120 is updated to reflect the newly added track. Depending upon the structure of such database, this step may involve nothing more than adding an entry for the new track. However, if the database maintains relationships between the various category types, categories and tracks, then it generally will be necessary in this step to insert all of the appropriate links to ensure that the new track is associated with all genres, artist, albums and any other categories to which it belongs. Moreover, new categories or category types may need to be added to properly characterize the new track.

In step 558, a determination is made as to whether this was the last track. If not, then processing proceeds to step 560 to receive the next track. Otherwise, the audio/video track downloading process is completed.

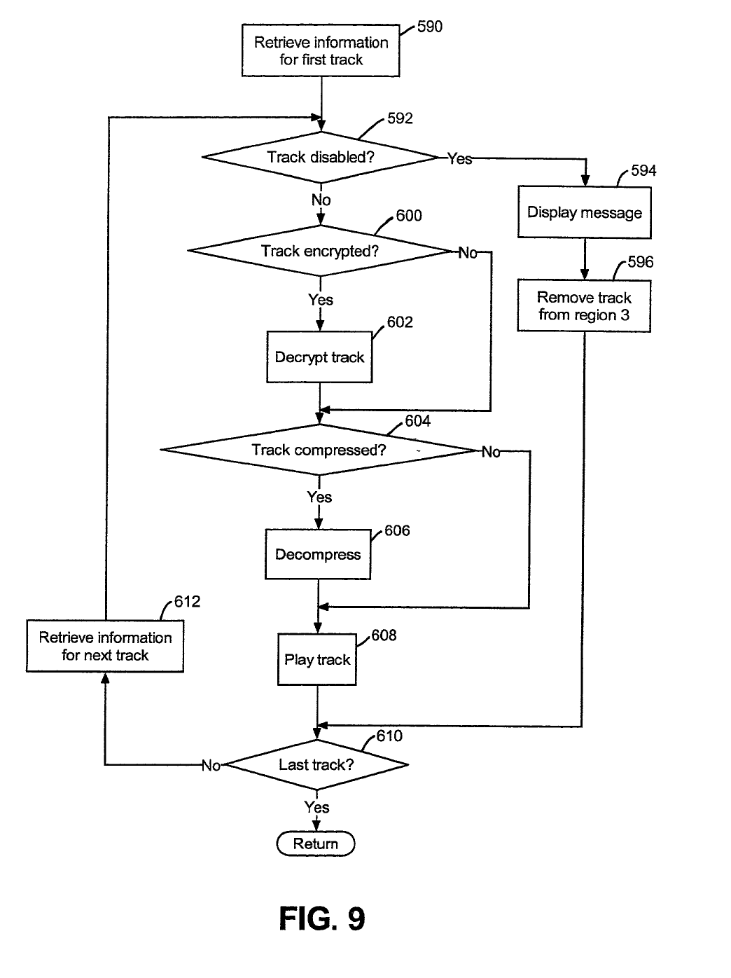

Once tracks have been stored in mass storage device 120, it will be desirable from time to time for the user to play a play list that she has constructed. FIG. 9 illustrates a flow diagram for explaining a method for playing a play list according to a representative embodiment of the present invention. Initially, in step 590, information for the first track for the play list is retrieved, such as from mass storage device 120.

In step 592, a determination is made as to whether the current track is disabled. Preferably, this will involve examining a Disabled flag. If the track is disabled, then processing proceeds to step 594 to display a message to that effect and then to step 596 to remove the listing for the track from the third region 390. It is possible to omit step 596 and simply not play the disabled track. If the track is not disabled, processing proceeds to step 600.

In step 600, a determination is made as to whether the track has been encrypted. Preferably, each track includes an indication as to whether and how it has been encrypted. If the track has been encrypted, it is decrypted in step 602. Preferably, any such encryption has been performed so that the subject audio/video track may only be decrypted using a decryption key that is unique to each specific device 100. Thus, in order to decrypt the track in step 602, system 100 retrieves or generates its unique decryption key and then uses that key to decrypt the track on-the-fly. Because the track is decrypted on-the-fly, an entire copy of the decrypted track is not maintained at any time by system 100, thereby further enhancing the security aspects of the present invention.

In step 604, a determination is made as to whether the track is compressed. Preferably, each track includes an indication as to whether and how it has been compressed. If the track has been compressed, decompression occurs in step 606. The specific decompression technique will depend upon the detected encryption. It is noted that any known compression/decompression techniques may be used for this purpose. However, as indicated above, the present invention preferably utilizes Lucent Technologies™ ePAC™ compression/decompression technology.

In step 608, the track is played. This preferably involves converting the track to a format that is suitable for output to an external device (such as an analog signal for output to a home stereo system) or to a signal that may be displayed and/or projected using internal speakers or an internal display panel.

In step 610, a determination is made as to whether the current track was the last track. If not, then processing proceeds to step 612 to retrieve information for the next track. If so, then processing is completed.

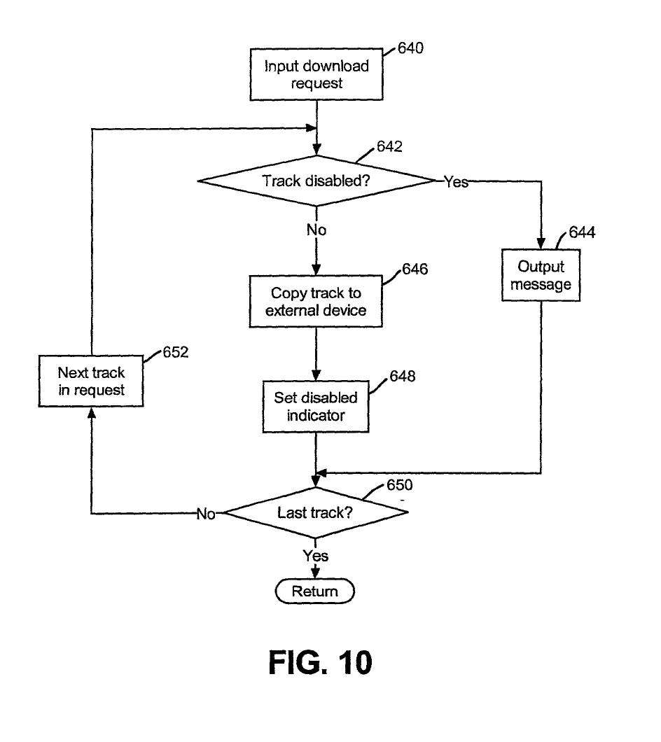

In the preferred embodiment of the invention, system 100 is provided with the capability to download digital copies of stored audio/video tracks to a portable playing device. Moreover, such downloading preferably is performed in a manner so as to prevent unauthorized copying. FIG. 10 illustrates a flow diagram for explaining such a downloading method according to a representative embodiment of the invention.

In step 640, system 100 receives a request to download one or more audio/video tracks to an external device. Preferably, such a download request is received via user interface 110. The following steps are then performed with respect to each such track.

In step 642, a determination is made as to whether the track is disabled. Preferably, this step involves examining a Disabled flag associated with the track. If the track is in fact disabled, then processing proceeds to step 644 to output a message to that effect and then to step 650. If not, then processing proceeds to step 646.

In step 646, a copy of the track is downloaded to the external device. Preferably this step will first involve decrypting the track using the device-specific decryption key. Thereafter, additional security measures may be taken, such as encrypting the track for decryption using a key that is specific to the external device. However, in the event that the external device lacks a digital output, then further copying is less of a concern, and so additional security measures often can be omitted. In addition, any other processing may be performed prior to copying the track to the external device, such as decompressing and then recompressing using a different compression technique.

In step 648, an indicator is set indicating that the copy of the device stored in mass storage device 120 is disabled from further playing or copying. Preferably, this step is performed by simply setting the Disabled flag associated with the track to the disabled state.

In step 650, a determination is made as to whether the current track is the last track designated for downloading. If not, then processing proceeds to step 652 to repeat the above processing with the next designated track. Otherwise, processing is completed.

In the embodiment discussed above, a single Disable flag is used to disable a track when a copy has been downloaded to and is available for playing from an external playback device. Other variations on this technique are also possible. For instance, system 100 may be configured so that a maximum of a fixed number of copies (e.g., 3) may be downloaded to external playback devices while still permitting system 100 to play the track. In this case, rather than maintaining a single flag for each track, a counter preferably would be maintained for each track to indicate how may copies have been downloaded (or how many copies are still available for downloading). On the other hand, if the maximum number of copies includes the copy available for playing on system 100, then the copy stored on system 100 would be disabled when the number of copies actually downloaded to external devices equals the maximum number. In any case, if a copy were previously downloaded to an external device and system 100 detects that such external device has deleted the copy or is otherwise disabled from playing it, then system 100 preferably increments the number of copies still available for downloading by 1.

Also, in the above embodiments the display screen and/or the navigation with respect to selecting tracks stored on the internal mass storage unit for playing and purchasing (or otherwise requesting) from a remote network node are substantially identical, preferably meaning that the only differences are dictated by functional considerations. This feature often makes operation more intuitive for the user. However, the requirement may be relaxed somewhat so that relatively unimportant implementation details, such as the colors used, exact panel sizes, text sizes and fonts, and decorative graphics may be different between the two modes.

In alternative embodiments, the display of tracks stored on the internal mass storage unit, tracks available for download, and/or device configuration and/or status information may be made simultaneously by an apparatus according to the present invention. Such simultaneous display may be on distinct portions of the display, such as on adjacent panels, or else such items may be integrally displayed on a display screen (e.g., by highlighting those tracks available for downloading that already exist on the internal mass storage unit).

Similarly, although in the preferred embodiment of the invention the user navigates based on category type and category, other navigation techniques are possible. For instance, the user might enter all or a portion of the name of the track, album or artist in addition to or instead of designating such categories and/or category types. In fact, any combination of searching and browsing may be utilized to allow the user to more efficiently designate desired tracks.

Conclusion

Thus, although the present invention has been described in detail with regard to the exemplary embodiments and drawings thereof, it should be apparent to those skilled in the art that various adaptations and modifications of the present invention may be accomplished without departing from the spirit and the scope of the invention. Accordingly, the invention is not limited to the precise embodiments shown in the drawings and described in detail above. Rather, it is intended that all such variations not departing from the spirit of the invention be considered as within the scope thereof as limited solely by the claims appended hereto.

Also, several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood those skilled in the art.

What is claimed is:

1. A method for entering a file selection, said method comprising:
(a) simultaneously displaying a first region, a second region and a third region;
(b) displaying on the first region a list of categories of files;
(c) inputting a first selection of one of the categories displayed in step (b), so as to identify a selected category;
(d) in response to said first selection, displaying on the second region a list of the files in the selected category;
(e) inputting a second selection of one of the files displayed on the second region, so as to identify a selected file; and
(f) in response to said second selection, displaying on the third region a name for the selected file.

2. A method according to claim 1, further comprising a step of inputting a third selection from a group of types of categories, so as to obtain a selected type, and wherein the categories displayed in step (b) are all of the selected type.

3. A method according to claim 2, wherein the selected type of category can be changed plural times, and wherein each time a different type of category is selected the displayed list of categories changes accordingly.

4. A method according to claim 2, wherein the selected type is a genre type and the categories displayed in step (b) are names of different genres.

5. A method according to claim 2, wherein the selected type is an artist type and the categories displayed in step (b) are names of different artists.

6. A method according to claim 2, wherein the selected type is an album type and the categories displayed in step (b) are names of different albums.

7. A method according to claim 1, wherein the first selection is made by highlighting and then selecting the selected category.

8. A method according to claim 1, wherein the selected category can be changed plural times, and wherein each time a different category is selected the list of files displayed in step (d) changes accordingly.

9. A method according to claim 1, wherein the second selection is made by highlighting and then selecting the selected file.

10. A method according to claim 1, further comprising steps of:
(g) inputting at least one additional selection of an file, so as to obtain an additionally selected file; and
(h) in response to each said additional file selection, adding a name for the additionally selected file to a list displayed in said third region.

11. A method according to claim 10, further comprising a step of inputting a play instruction, and wherein in response to the play instruction, all files listed in the third region are played.

12. A method according to claim 1, further comprising steps of:
(g) displaying a menu of options;
(h) inputting a selection of one of the options, so as to obtain a selected option; and
(i) populating the first region, the second region and the third region based on the selected option.

13. A method according to claim 12, wherein the selected option is to play files, and wherein in step (i) the first region and the second region are populated with information pertaining to stored files.

14. A method according to claim 12, wherein the selected option is to purchase files, and wherein in step (i) the first region and the second region are populated with information pertaining to files that are available for purchase.

15. A method according to claim 14, wherein at least some of the information pertaining to files that are available for purchase is obtained from a remote node via a communications network.

16. A method according to claim 15, wherein the communications network comprises an Internet.

17. A method according to claim 1, further comprising a step of displaying a plurality of soft buttons, each said soft button for selecting a function.

18. A method according to claim 17, further comprising a step of inputting a third selection from a group of types of categories, so as to obtain a selected type, and wherein the functions associated with each soft button depend upon the selected type.

19. A method according to claim 1, further comprising a step of inputting a selection of one of the first region, the second region and the third region, so as to obtain a selected region, and wherein selections can only be made in the selected region.

20. An apparatus for entering a file selection, said apparatus comprising:
(a) means for simultaneously displaying a first region, a second region and a third region;
(b) means for displaying on the first region a list of categories of files;
(c) means for inputting a first selection of one of the categories displayed in step (b), so as to identify a selected category;
(d) means for, in response to said first selection, displaying on the second region a list of the files in the selected category;
(e) means for inputting a second selection of one of the files displayed on the second region, so as to identify a selected file; and
(f) means for, in response to said second selection, displaying on the third region a name for the selected file.

21. An apparatus according to claim 20, further comprising means for inputting a third selection from a group of types of categories, so as to obtain a selected type, and wherein the categories displayed in step (b) are all of the selected type.

22. An apparatus according to claim 21, wherein the selected type of category can be changed plural times, and wherein each time a different type of category is selected the displayed list of categories changes accordingly.
